(19) United States
(12) Patent Application Publication
(10) Pub. No.: US 2023/0385458 A1
(43) Pub. Date: Nov. 30, 2023

(54) COMPUTER-READABLE RECORDING MEDIUM STORING MEASUREMENT PROGRAM, MEASUREMENT METHOD, AND MEASUREMENT APPARATUS

(71) Applicant: Fujitsu Limited, Kawasaki-shi (JP)

(72) Inventors: Kentaro TSUJI, Kawasaki (JP); Mayuko KANEKO, Kawasaki (JP); Masayoshi SHIMIZU, Hadano (JP)

(73) Assignee: Fujitsu Limited, Kawasaki-shi (JP)

(21) Appl. No.: 18/166,509

(22) Filed: Feb. 9, 2023

(30) Foreign Application Priority Data
May 31, 2022 (JP) 2022-089030

(51) Int. Cl. G06F 21/64

(52) U.S. Cl. CPC G06F 21/64

(57) ABSTRACT

A recording medium storing a measurement program for causing a computer to execute a process for measuring an information literacy degree of a user. The process includes measuring a knowledge amount of a user related to an action when responding to suspicious information from a browsed history of a user terminal, specifying the suspicious information among browsed articles included in the browsed history, predicting executable actions by the user from the knowledge amount, detecting, from an operation log of the user terminal, an execution action executed by the user when browsing the suspicious information, and measuring an information literacy degree of the user based on a difference between an action with a best evaluation among the executable actions and the execution action.

### CROSS-REFERENCE TO RELATED APPLICATION

This application is based upon and claims the benefit of priority of the prior Japanese Patent Application No. 2022-89030, filed on May 31, 2022, the entire contents of which are incorporated herein by reference.

### FIELD

The embodiments discussed herein are related to a computer-readable recording medium storing a measurement program, a measurement method, and a measurement apparatus.

### BACKGROUND

Information such as news, articles, and the like is quoted from various news sources in curation media and social media. With a development of these media, individuals are more likely to transmit information, and as a result, the immediacy, variety, ease of sharing, and the like of information are increasing, while suspicious information that is suspicious as to whether it is true or not is also spreading.

For example, the “suspicious information” referred to herein may include normal information of which a genuineness is unclear, and may include, for example, fake information or the like that may be found to be erroneous information or false information over time.

From an aspect of suppressing the spread of such suspicious information, it is desired to increase an information literacy in society as a whole. For example, there is an aspect in which it is possible for a person having a high information literacy to take an action for suppressing the spread of the suspicious information, while it is difficult for a person having a low information literacy to take an action for suppressing the spread of the suspicious information.

For this reason, in order to suppress the spread of the suspicious information, support in accordance with a degree of an information literacy of each person, for example, a notification for prompting an action for suppressing the spread of the suspicious information, or the like is desired. Although such a notification is useful for the person having a low information literacy, since the person having a high information literacy is notified of one that the person already knows or has acted, the notification is not only of no value but also troublesome, and as a result, there is a case where the convenience is impaired.

From this, a mechanism for measuring an information literacy is desired, but there is an aspect in which it takes time and effort, for example, time and effort on both a side that executes a test or a questionnaire and a side that receives the test or the questionnaire for measuring the literacy currently executed.

From such an aspect, as one of techniques for implementing automatic measurement of the information literacy, a literacy level estimation system for estimating a literacy level related to a specific field has been proposed. For example, in the literacy level estimation system, a text is extracted from the information exchanged by input and output functions of a user terminal apparatus. A technical term in a specific field is detected from the text extracted in this manner, and points are given in accordance with a status in which the information from which the technical term is detected is used. As described above, the literacy level is determined based on a total value of the points given in accordance with the technical terms detected from the text.

Japanese Laid-open Patent Publication Nos. 2017-182447 and 2013-092830, and U.S. Patent Application Publication Nos. 2018/0081969 and 2019/0179861 are disclosed as related art.

### SUMMARY

According to an aspect of the embodiments, a non-transitory computer-readable recording medium storing a measurement program for causing a computer to execute a process comprising: measuring a knowledge amount of a user related to an action when responding to suspicious information from a browsed history of a user terminal; specifying the suspicious information among browsed articles included in the browsed history; predicting executable actions by the user from the knowledge amount; detecting, from an operation log of the user terminal, an execution action executed by the user when browsing the suspicious information; and measuring an information literacy degree of the user based on a difference between an action with a best evaluation among the executable actions and the execution action.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a system;

FIG. 2 is a schematic diagram illustrating one aspect of a problem-solving approach;

FIG. 3 is a block diagram illustrating a functional configuration example of a server apparatus;

FIG. 4 is a diagram illustrating an example of action knowledge data;

FIG. 5 is a diagram illustrating an example of determination knowledge data;

FIG. 6 is a diagram illustrating an example of action option data;

FIG. 7 is a diagram illustrating a notification example of an information literacy degree;

FIG. 8 is a flowchart illustrating a procedure of knowledge data collection processing;

FIG. 9 is a flowchart illustrating a procedure of information literacy degree measurement processing; and

FIG. 10 is a diagram illustrating a hardware configuration example.

### DESCRIPTION OF EMBODIMENTS

In the above-described literacy level estimation system, since there is a case where the information literacy may not be accurately measured for the following reason, there is an aspect in which it is difficult to execute the notification for prompting the suppression of the spread of the suspicious information in accordance with the information literacy of each person.

For example, in the above-described literacy level estimation system, the literacy level is determined only by a knowledge amount indicating whether the user often comes into contact with technical terms via the user terminal apparatus, regardless of an actual state whether the user is able to understand and utilize the information. For this reason, in some cases, a literacy level of a user who often comes into contact with the technical terms via the user terminal apparatus is overestimated, or a literacy level of a user who does not often come into contact with the technical terms via the user terminal apparatus is underestimated.

As an example only, a case where a user A and a user B who have a difference in the knowledge amount related to the information literacy perform the same action when browsing the same information is exemplified. For example, in a case where the knowledge amount of the user A is larger than the knowledge amount of the user B, the best action that the user B may take from the aspect of suppressing the spread of the suspicious information when browsing the suspicious information is not necessarily the best for the user A. For example, there is a case where although the user A is able to execute an action better than the best action for the user B, the user A takes only the action similar to that of the user B.

Even in such a case, in the above-described literacy level estimation system, the literacy level of the user A who does not do his/her best is evaluated higher than the literacy level of the user B who does his/her best. For this reason, according to the above-described literacy level estimation system, it is difficult to highly evaluate the literacy level of a user who performs better selection among actions executable with the knowledge amount of the user. Even when a notification is performed in accordance with such a literacy level, it is difficult to implement a notification suitable for the information literacy of each person.

According to one aspect, an object of the present disclosure is to provide a measurement program, a measurement method, and a measurement apparatus that are capable of implementing a notification for prompting suppression of a spread of suspicious information in accordance with an information literacy of each person.

Hereinafter, embodiments of a measurement program, a measurement method, and a measurement apparatus, which are disclosed herein, are described with reference to the accompanying drawings. Each of the embodiments represents only one example or one aspect, and such exemplification does not limit ranges of numerical values or functions, a usage scene, or the like. Each of the embodiments may be appropriately combined within a range not causing any contradiction in the processing content.

### Embodiment 1

### System Configuration

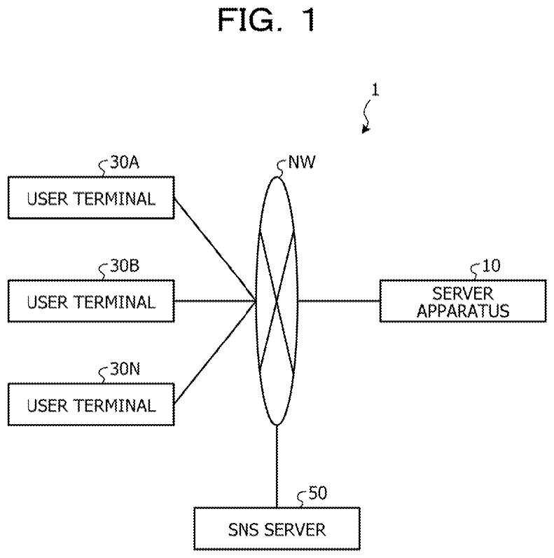

FIG. 1 is a diagram illustrating a configuration example of a system. As illustrated in FIG. 1, a system 1 may include a server apparatus 10, user terminals 30A to 30N, and a social networking service (SNS) server 50. Hereinafter, there is a case where the user terminals 30A to 30N are referred to as a “user terminal 30”.

The server apparatus 10, the user terminal 30, and the SNS server 50 may be communicably coupled to each other via a network NW. For example, the network NW may be an arbitrary type of wired or wireless communication network such as the Internet or a local area network (LAN).

The server apparatus 10 is an example of a computer that provides a measurement function of measuring an information literacy degree of a user of the user terminal 30. As one embodiment, the server apparatus 10 may be implemented as a platform as a service (PaaS) type application or a software as a service (SaaS) type application, thereby providing the above-described measurement function as a cloud service. As another embodiment, the server apparatus 10 may be implemented as a server that provides the measurement function described above on-premise.

The user terminal 30 is a terminal apparatus used by a user who receives provision of the above-described measurement function. The user terminal 30 may be implemented by an arbitrary information processing apparatus such as a personal computer, a mobile terminal apparatus, and a wearable terminal.

The SNS server 50 is a server apparatus operated by a service provider that provides an SNS. As one aspect, the SNS server 50 provides various kinds of services related to the SNS to the user terminal 30 in which an application for a client that receives the provision of the SNS is installed. As an example only, the SNS server 50 may provide a profile function, a reply function of making a reply to a post of another SNS user, a quote function of quoting a post of another SNS user, a reaction function of indicating a reaction such as an impression to a post of another SNS user, and the like in addition to a message posting function.

Although FIG. 1 illustrates an example in which the above-described measurement function is provided by a client server system, this is merely an example, and the above-described measurement function may be provided in a stand-alone manner. Although FIG. 1 illustrates an example in which the server apparatus 10 and the SNS server 50 are configured in a distributed manner, the measurement function described above may be incorporated in the SNS server 50.

### One Aspect of Problem

As explained above, there is a case where the information literacy may not be accurately measured.

As in the example above, the literacy level of the user A who does not do his/her best is evaluated higher than the literacy level of the user B who does his/her best. For this reason, according to the above-described literacy level estimation system, it is difficult to highly evaluate the literacy level of a user who performs better selection among actions executable with the knowledge amount of the user. Even when a notification is performed in accordance with such a literacy level, it is difficult to implement a notification suitable for the information literacy of each person.

### One Aspect of Problem-Solving Approach

Accordingly, the measurement function according to the present embodiment measures the information literacy degree based on a gap between the best action executable by the user specified from a browsed history of the user terminal and an execution action detected from an operation log of the user terminal when browsing the suspicious information.

As an example only, in a case where the knowledge amount of the user A is larger than the knowledge amount of the user B, the number of options of an action executable by the user A is also larger than the number of options of an action executable by the user B.

At this time, in a case where the user A and the user B browse the same information, even when the user A may identify that the information browsed by the user A himself/herself is suspicious information, there is a case where it is difficult for the user B to identify the same information as suspicious information.

In this case, the user A may have an option up to an action such as “notify a transmitter that it is a hoax” or “transmit correct information”. On the other hand, it is difficult for the user B who may not identify that it is suspicious information to select the action such as “notify a transmitter that it is a hoax” or “transmit correct information”, and the best option for the user B is limited to an action such as “ignore the information”.

Although the number of options of the executable action is different as described above, evaluating the actions of both the user A and the user B equally because the user A and the user B executed the same action leads to an evaluation that lacks fairness, even when there is equality.

For example, in a case where both the user A and the user B execute an action such as “ignore the information”, the action only remains at a level of “not being deceived” and does not reach a level of “suppressing others from being deceived”.

At this time, there is a case where the user A who has more knowledge amount than the user B executes an action of “ignore the information” even when there is a knowledge amount for taking an action that is more useful for suppressing the spread of the suspicious information than the action of “ignore the information”, for example, “transmitting correct information”.

In this case, as in the literacy level estimation system described above, when the information literacy degree of the user A is measured higher than the information literacy degree of the user B, the user B, who does his/her best, will be underestimated, while the user A, who does not do his/her best, will be overestimated.

From this, with the measurement function according to the present embodiment, the information literacy degree is measured based on the difference between the best action among the actions executable by the user and the execution action executed when browsing the suspicious information. As an example only, the larger the gap between the best action executable by the user and the execution action executed when browsing the suspicious information, the lower the information literacy degree is measured, while the smaller the gap, the higher the information literacy degree is measured.

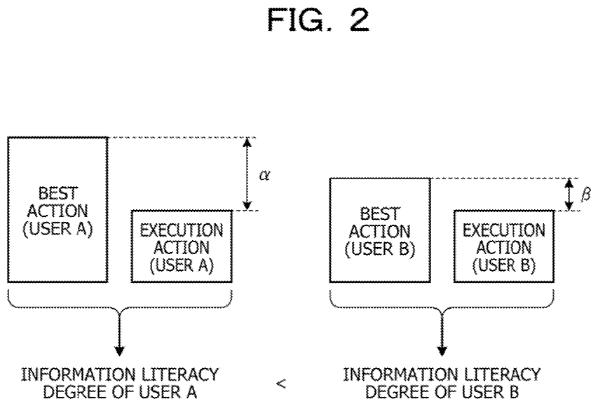

FIG. 2 is a schematic diagram illustrating one aspect of a problem-solving approach. FIG. 2 illustrates a gap between the best action executable by the user and the execution action executed when browsing the suspicious information for each of the two users of the user A and the user B. As illustrated in FIG. 2, a gap a between the evaluation of the best action and the evaluation of the execution action of the user A is larger than a gap β between the evaluation of the best action and the evaluation of the execution action of the user B. In this case, the measurement result of the information literacy degree of the user A has a lower evaluation than the measurement result of the information literacy degree of the user B. Accordingly, since it is possible to suppress underestimation of the user B who does his/her best and overestimation of user A who does not do his/her best, it is possible to improve the evaluation of the information literacy of the user who executes a better action among the actions executable with the knowledge amount of the user.

Accordingly, with the measurement function according to the present embodiment, it is possible to implement a notification for prompting the suppression of the spread of the suspicious information in accordance with the information literacy of each person.

### Configuration of Server Apparatus 10

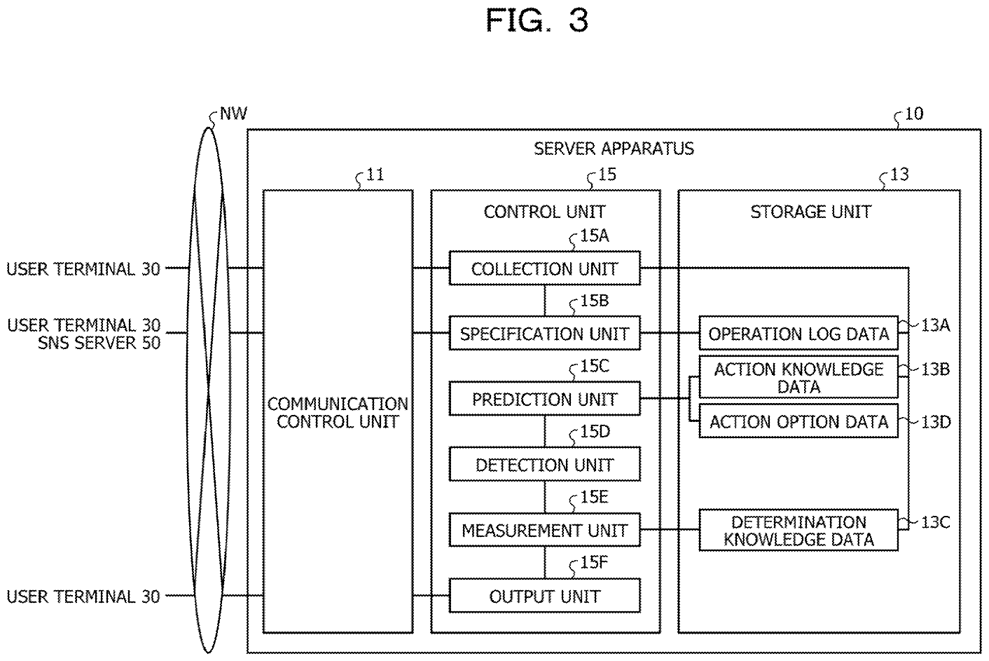

Next, a functional configuration example of the server apparatus 10 having a measurement function according to the present embodiment is described. FIG. 3 is a block diagram illustrating a functional configuration example of the server apparatus 10. FIG. 3 schematically illustrates blocks corresponding to the measurement function described above. As illustrated in FIG. 3, the server apparatus 10 includes a communication control unit 11, a storage unit 13, and a control unit 15. FIG. 3 only illustrates an extraction of functional units related to the measurement function described above, and does not hinder the server apparatus 10 from including functional units other than those illustrated.

The communication control unit 11 is a functional unit that controls communication with other apparatuses such as the user terminal 30 or the SNS server 50. As an example only, the communication control unit 11 may be implemented by a network interface card such as a LAN card. As one aspect, the communication control unit 11 receives a request such as information literacy measurement from the user terminal 30, or outputs a measurement result of the information literacy, a notification corresponding to the measurement result, or the like to the user terminal 30. As another aspect, the communication control unit 11 outputs, to the SNS server 50, a request for transmission of an SNS use status related to a user of a specific account, and receives the SNS use status replied from the SNS server 50.

The storage unit 13 is a functional unit that stores various kinds of data. As an example only, the storage unit 13 is implemented by an internal, external, or auxiliary storage of the server apparatus 10. For example, the storage unit 13 stores operation log data 13A, action knowledge data 13B, determination knowledge data 13C, and action option data 13D. Descriptions of the operation log data 13A, the action knowledge data 13B, the determination knowledge data 13C, and the action option data 13D will be provided together with a scene where reference, generation, or registration is executed.

The control unit 15 is a functional unit that performs overall control of the server apparatus 10. For example, the control unit 15 may be implemented by a hardware processor. Alternatively, the control unit 15 may be implemented by a hard wired logic. As illustrated in FIG. 3, the control unit 15 includes a collection unit 15A, a specification unit 15B, a prediction unit 15C, a detection unit 15D, a measurement unit 15E, and an output unit 15F.

The collection unit 15A is a processing unit that collects various kinds of information from the user terminal 30. As an example only, the collection unit 15A may collect an operation log of the user terminal 30 from the user terminal 30 at an arbitrary timing such as a periodic time, a certain cycle, or a command from a system administrator or the like. For example, the collection unit 15A may collect the operation log by distributing the setting of the timing of collecting the operation log to an agent program operating over the user terminal 30 or transmitting a transmission request for the operation log to the agent program. The operation log acquired in this manner is added to and stored in the operation log data 13A stored in the storage unit 13.

As an example only, the operation log data 13A may include logs related to operations of various kinds of input devices, mail software, a browser, or a specific program, for example, an application for a user of an SNS. Hereinafter, there is a case where the application is referred to as an “application”. For example, the operation log data 13A may be data in which items such as the date and time when the log was collected, the type of the log, and the content of the operation are associated with each other.

After collecting such operation logs, the collection unit 15A updates the action knowledge data 13B and the determination knowledge data 13C based on a browsed history of a browser or an SNS application among the operation logs. Hereinafter, there is a case where knowledge related to an action taken by a user from an aspect of suppressing the spread when browsing suspicious information is referred to as “action knowledge”, and knowledge from an aspect of determining whether an article browsed by the user is suspicious information is referred to as “determination knowledge”.

In more detail, the collection unit 15A acquires a browsed history of a browser, for example, a browsed article corresponding to a Uniform Resource Locator (URL), for example, a Web page, an SNS post, or the like. Subsequently, the collection unit 15A extracts the browsed article in which a source of the browsed article satisfies a specific condition among the browsed articles. For example, a Web site that may transmit fake information such as false information or erroneous information, for example, an SNS or a bulletin board site may be registered in a negative list, an article on the Web site registered in the negative list may be excluded, and a browsed article other than that may be extracted. Alternatively, the collection unit 15A calculates reliability of the browsed article by using a technology for determining an authenticity of the news from the transmission source reliability, a signature and related information of a journalist, and an article tendency score, for example, a technique of Japanese Laid-open Patent Publication No. 2021-73621 or the like. The collection unit 15A may extract a browsed article of which reliability is equal to or greater than a threshold.

After that, the collection unit 15A executes the following processing for each of the extracted browsed articles. For example, the collection unit 15A executes natural language processing on the text of the browsed article. For example, the collection unit 15A executes morphological analysis on the text of the browsed article to acquire words included in the text.

As described above, based on the words included in the text of the browsed article, the collection unit 15A determines whether any knowledge of the action knowledge or the determination knowledge is included in the browsed article. For example, when words related to the action knowledge or the determination knowledge are registered in a positive list, it is possible to determine whether the action knowledge or the determination knowledge is included in the browsed article depending on whether the word registered in the positive list is included. At this time, it may be determined that the action knowledge or the determination knowledge is included in the browsed article only in a case where a plurality of words are included in an AND condition or an OR condition. Although an example has been exemplified in which whether the action knowledge or the determination knowledge is included in the browsed article is determined by a word included in the text, the determination may be performed by using the positive list in which a Web page or a Web site in which the action knowledge or the determination knowledge is described is registered.

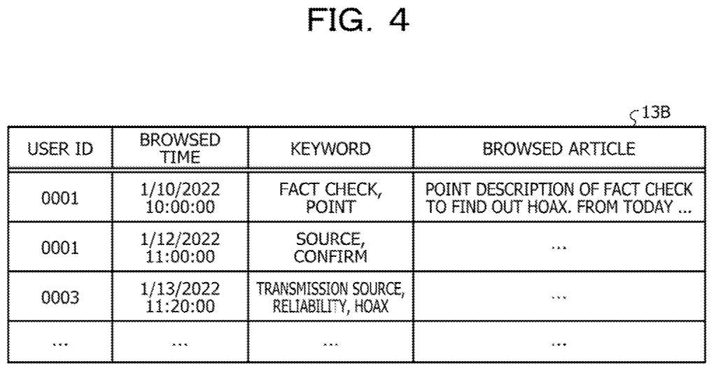

In a case where the action knowledge is included in the browsed article, the collection unit 15A generates a data entry related to the action knowledge from the browsed article and additionally registers the data entry in the action knowledge data 13B of the storage unit 13. FIG. 4 is a diagram illustrating an example of the action knowledge data 13B. As illustrated in FIG. 4, the action knowledge data 13B includes a user identification (ID), a browsed time, a keyword, text, and the like. The “user ID” corresponds to an example of user identification information. The “browsed time” refers to a time at which the browsed article is browsed. The “keyword” refers to a keyword extracted from the browsed article, and for example, only a keyword related to the action knowledge may be extracted. The “text” refers to the text of the browsed article. In an example of an entry on a first line illustrated in FIG. 4, it may be seen that the keyword such as “fact check” is extracted as an example of the keyword related to the action knowledge from the article browsed by a user with the user ID “0001” on Jan. 10, 2022.

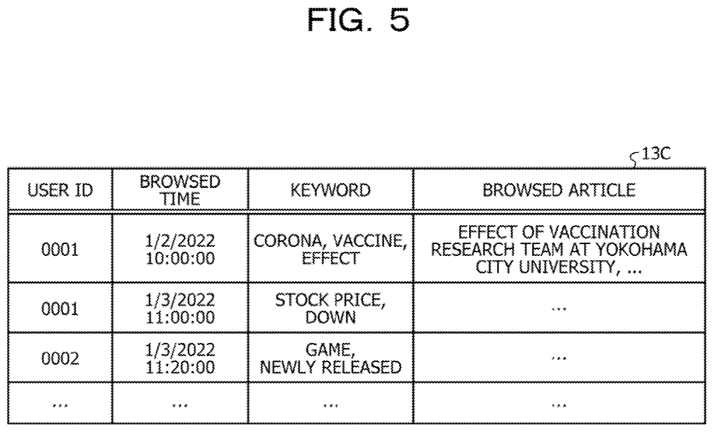

In a case where the determination knowledge is included in the browsed article, the collection unit 15A generates a data entry related to the determination knowledge from the browsed article and additionally registers the data entry in the determination knowledge data 13C of the storage unit 13. FIG. 5 is a diagram illustrating an example of the determination knowledge data 13C. As illustrated in FIG. 5, the determination knowledge data 13C includes a user ID, a browsed time, a keyword, a text, and the like. The “user ID” corresponds to an example of user identification information. The “browsed time” refers to a time at which the browsed article is browsed. The “keyword” refers to a keyword extracted from the browsed article, and for example, only a keyword related to the determination knowledge may be extracted. The “text” refers to the text of the browsed article. In an example of an entry on a first line illustrated in FIG. 5, it may be seen that the keywords such as “corona”, “vaccine”, and “effect” are extracted as examples of the keywords related to the determination knowledge from the article browsed by the user with the user ID “0001” on Jan. 2, 2022.

Although an example in which the action knowledge data 13B and the determination knowledge data 13C are individually managed has been exemplified, the action knowledge and the determination knowledge may be integrated into one piece of data by using a flag or a code representing a type of the action knowledge and the determination knowledge. Although a case where the action knowledge data 13B and the determination knowledge data 13C are stored in a table format has been exemplified as an example, this is merely an example and a data structure is not limited to a relational database. For example, the data may be data described in a tag format by a markup language such as an Extensible Markup Language (XML), or may be data described by a comma or a line break such as comma-separated values (CSV).

Although a Web page, which is a content of a Web site, has been exemplified as an example of a source that generates the action knowledge data 13B and the determination knowledge data 13C, the source is not limited to this. For example, the source may be mail distributed by a distribution service of a news site. In this case, it is possible to generate the action knowledge data 13B or the determination knowledge data 13C by using a reception history of the mail in which a transmission source is the news site.

The specification unit 15B is a processing unit that specifies the suspicious information. As an example only, although an example in which the measurement function operates by receiving a measurement request for the information literacy degree from the user terminal 30 is exemplified below, the measurement function may operate at an arbitrary timing. As an example only, the specification unit 15B acquires a browsed article included in the browsed history of the user who makes the measurement request among the browsed histories included in the operation log data 13A stored in the storage unit 13. Since the browsed article acquired is used for checking the suspicious information, the browsed article may include an article with low reliability transmitted by an SNS or a bulletin board site. Besides such a browsed article, an application programming interface (API) made public by the SNS server 50 may be used to further collect information such as a post or a profile of the user as an issue source of the measurement request.

The specification unit 15B determines whether the browsed article is suspicious information. As an example only, the specification unit 15B may use an existing method such as a method for determining a suspicious remark (a remark or information with suspicion in accuracy) used in a fact check initiative. Alternatively, the specification unit 15B may also collate information verified as fake information by a fact check organization or the like with the browsed article. In this case, the specification unit 15B may specify the browsed article which is the suspicious information based on whether the URL or the title of the browsed article is included in a fake information list that lists fake information addresses, such as URLs or titles of the fake information.

The prediction unit 15C is a processing unit that predicts an action executable by the user when responding to the suspicious information. Hereinafter, the action executable by the user when responding to the suspicious information may be referred to as an “executable action”. As an example only, the prediction unit 15C extracts all the actions registered in the action option data 13D stored in the storage unit 13.

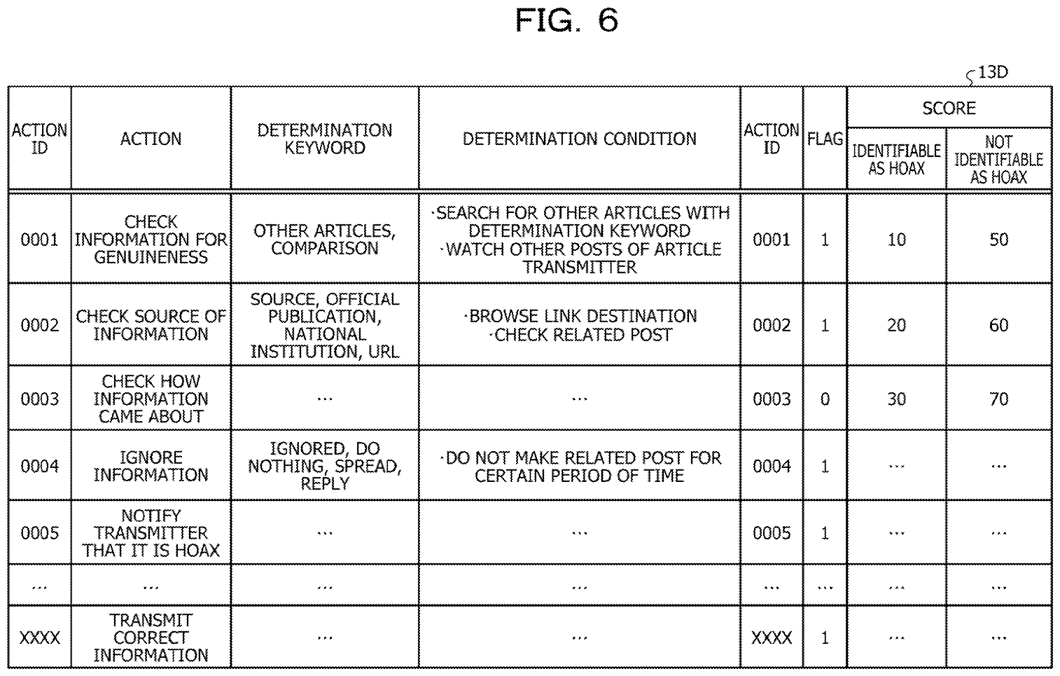

FIG. 6 is a diagram illustrating an example of the action option data 13D. As illustrated in FIG. 6, the action option data 13D may be data in which items such as an action ID, an action content, a determination keyword, a determination condition, and a flag are associated with each other.

The “action ID” referred to herein corresponds to an example of identification information of an action selected when browsing the suspicious information. As an example, the “action” may be represented by a name or a definition of the action. The “determination keyword” refers to a keyword used for determining the presence or absence of knowledge that enables an action to be executed, and may be collated with, for example, a keyword included in an entry related to the user as an issue source of the measurement request among the action knowledge data 13B. For example, it is possible to collect Web pages including a description related to the action knowledge by a crawler or the like, and to register a word of which an appearance frequency or a term frequency-inverse document frequency (tf-idf) is equal to or greater than a threshold.

A “determination condition” refers to a condition for determining whether an action may be executed, and may be collated with a log included in the operation log data 13A, for example. The “flag” corresponds to an example of information indicating the presence or absence of knowledge requested to execute an action corresponding to each entry. For example, the flag is reset to an initial value, for example “0”, at the start of the measurement, and then updated to “1” when there is the knowledge desired to execute the action, while it remains “0” and is not updated when there is no knowledge desired to execute the action.

The “score” refers to a degree to which an action contributes to suppressing the spread of the suspicious information. For example, different score values are set for the scores depending on whether the user is able to identify the suspicious information. At this time, a higher value is set for a case where the suspicious information is not identifiable than for a case where the suspicious information is identifiable.

All types of actions that may be assumed to be executed by the user when responding to the suspicious information may be listed in the action option data 13D illustrated in FIG. 6. For example, in the example of the action option data 13D illustrated in FIG. 6, entries corresponding to the respective actions are arranged in an ascending order of the evaluations of the actions.

Subsequently, the prediction unit 15C extracts an executable action of the user as an issue source of the measurement request among all the actions extracted from the action option data 13D.

In more detail, the prediction unit 15C executes the following processing for each entry included in the action option data 13D. For example, the determination keyword of the entry of the action option data 13D is collated with keywords of all the entries related to the user as an issue source of the measurement request among the action knowledge data 13B. As a result, a ratio of the determination keywords matching the keywords of the action knowledge data 13B to the total number of determination keywords of the action option data 13D is calculated as a matching degree.

When the matching degree calculated in this manner is equal to or greater than a threshold, it may be estimated that there is knowledge requested to execute the action. In this case, the flag included in the entry of the action option data 13D is updated to “1”.

On the other hand, when the matching degree is not equal to or greater than the threshold, it may be estimated that there is no knowledge requested to execute the action. In this case, the flag included in the entry of the action option data 13D remains “0” and is not updated.

By executing the determination of the matching degree and the update of the flag for each entry included in the action option data 13D, the entry of the action option data 13D for which the flag is updated to “1” may be extracted as the executable action. For example, in the example of the action option data 13D illustrated in FIG. 6, five actions corresponding to the action ID “0001”, an action ID “0002”, an action ID “0004”, an action ID “0005”, and an action ID “XXXX” are extracted as the executable actions.

An example of imposing a condition that the keywords of both the action knowledge data 13B and the action option data 13D match at a specific ratio has been exemplified, but the present embodiment is not limited to this. For example, the determination condition may be a case where the number of records of the action knowledge data 13B having a keyword matching the keyword of each record of the action option data 13D at a predetermined ratio is equal to or greater than a threshold. Alternatively, in a case where there is a record related to an action among a book purchase record or a course record of e-learning registered in a user profile (not illustrated), it may be estimated that there is knowledge requested to execute the action.

The detection unit 15D is a processing unit that detects from the operation log of the user terminal 30 the execution action executed by the user when browsing the suspicious information. As an example only, the detection unit 15D determines whether the determination condition for executability of the entry is satisfied for each of the entries included in the action option data 13D. As a result, in a case where there is an entry that satisfies the determination condition for executability, it is detected that the action of the entry has been executed. At this time, in a case where there are a plurality of entries satisfying the determination condition for executability, it is detected that the action of the entry having the highest action ID has been executed.

At the time of determination for executability, an entry of the operation log data 13A stored after the browsed time of the suspicious information among the operation log data 13A is referred to. For example, in an example of an entry on a first line of the action option data 13D illustrated in FIG. 6, when the determination condition that there is a keyboard input history of the words “other articles” and “comparison” corresponding to the determination keyword is satisfied, it may be detected that the action “check information for genuineness” has been executed. Alternatively, when there is a browsed history of referring to other SNS posts of the transmitter who transmits the SNS post of the suspicious information, it may also be detected that the action “check information for genuineness” has been executed. As an example of an entry on a second line, in a case where there is a browsed history of referring to a link destination included in the SNS post of the suspicious information, it may be detected that the action “check a source of information” has been executed. For the other entries, whether the determination condition is satisfied is determined in the same manner.

The measurement unit 15E is a processing unit that measures the information literacy degree of the user based on a difference between the action with the best evaluation among the executable actions and the execution action. As an example only, the measurement unit 15E determines whether the user is able to identify the browsed article as suspicious information. For example, the measurement unit 15E extracts, among the determination knowledge data 13C, entries that are entries of the user as an issue source of the measurement request and are stored after the browsed time of the suspicious information. The measurement unit 15E executes the following processing for each entry extracted from the determination knowledge data 13C. For example, the measurement unit 15E calculates, as the matching degree, a ratio of keywords matching keywords included in the text of the browsed article specified as the suspicious information to the total number of keywords in the entries of the determination knowledge data 13C. When there is an entry having such a matching degree equal to or greater than a threshold, it is determined that the user is able to identify the browsed article as the suspicious information. At this time, it may be determined that the user is able to identify the browsed article as the suspicious information only when the number of entries having a matching degree equal to or greater than a threshold is equal to or greater than a threshold.

After such determination, the measurement unit 15E selects the best action to which the highest score is set among the executable actions predicted by the prediction unit 15C. For example, an action having the highest action ID or the highest score among the actions for which “1” is set in the flag of the action option data 13D is selected as the best action. The measurement unit 15E refers to the score given to the best action selected from the executable actions among the action option data 13D and the score given to the execution action detected by the detection unit 15D. At this time, the measurement unit 15E changes the type of the score to be referred to, among the two types of scores defined in the action option data 13D, in accordance with the determination result as to whether the user is able to identify the browsed article as suspicious information. For example, the measurement unit 15E refers to a score in a column “identifiable as suspicious information” when the user is able to identify the browsed article as suspicious information, and refers to a score in a column “not identifiable as suspicious information” when the user is not able to identify the browsed article as suspicious information. The measurement unit 15E calculates an information literacy degree L by substituting the score of the best action and the score of the execution action into the following formula (1).

information literacy degree L=score of execution action/max (score of best action) (1)

The output unit 15F is a processing unit that outputs a notification based on the information literacy degree. As an example only, the output unit may output a notification including the information literacy degree measured by the measurement unit 15E to the user terminal 30. As an example, such a notification may be implemented by at least one or more of sound output, display output, and print output. Alternatively, the output unit 15F may also output a notification by narrowing down when the information literacy degree is equal to or less than a threshold. In this case, as the information literacy degree decreases, the notification may be output as an alert with a higher warning degree.

Alternatively, the measurement unit 15E may output a notification including a recommendation corresponding to the information literacy degree instead of the information literacy degree itself. For example, the measurement unit 15E may output a recommendation notification that prompts an action that is able to be measured with a higher information literacy degree than an information literacy degree measured based on the execution action detected by the detection unit 15D. For example, in the example of the action option data 13D illustrated in FIG. 6, it is possible to recommend an action having an action ID of which a numerical value is larger than the action ID of the execution action, or an action having a score larger than the score of the execution action. At this time, it is also possible to recommend the second best action of the execution action, for example, the action having an action ID next to the action ID of the execution action, or an action having a score larger than the score of the execution action and the smallest score.

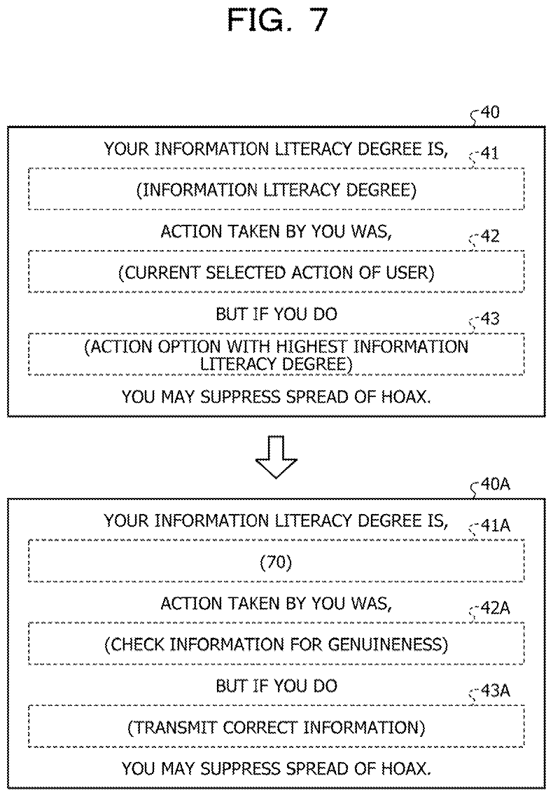

FIG. 7 is a diagram illustrating a notification example of the information literacy degree. As an example only, FIG. 7 schematically illustrates a format 40 of display data. As illustrated in FIG. 7, the format 40 includes areas 41 to 43 in which text is changeable. For example, in an example of an HTML source, this may be implemented by designating an information literacy degree, an execution action, and a return value of recommendation with var tags. Accordingly, it is possible to generate display data 40A including text 41A in which “70” is described as the information literacy degree, text 42A in which “check information for genuineness” is described as the execution action, and text 43A in which “transmit correct information” is described as the recommendation. By notifying the display data 40A including such a recommendation, it is possible to implement a notification for prompting the suppression of the spread of the suspicious information, and thus it is possible to suppress the spread of the suspicious information.

An output destination of the notification is not limited to the user terminal 30, and may be an external apparatus other than the user terminal 30, or software or a service using the information literacy degree, or the like.

### Flows of Processing

Flows of processing performed by the server apparatus 10 according to the present embodiment will be described next. Description will be given of (1) knowledge data collection processing executed by the server apparatus 10 and then of (2) information literacy degree measurement processing.

### (1) Knowledge Data Collection Processing

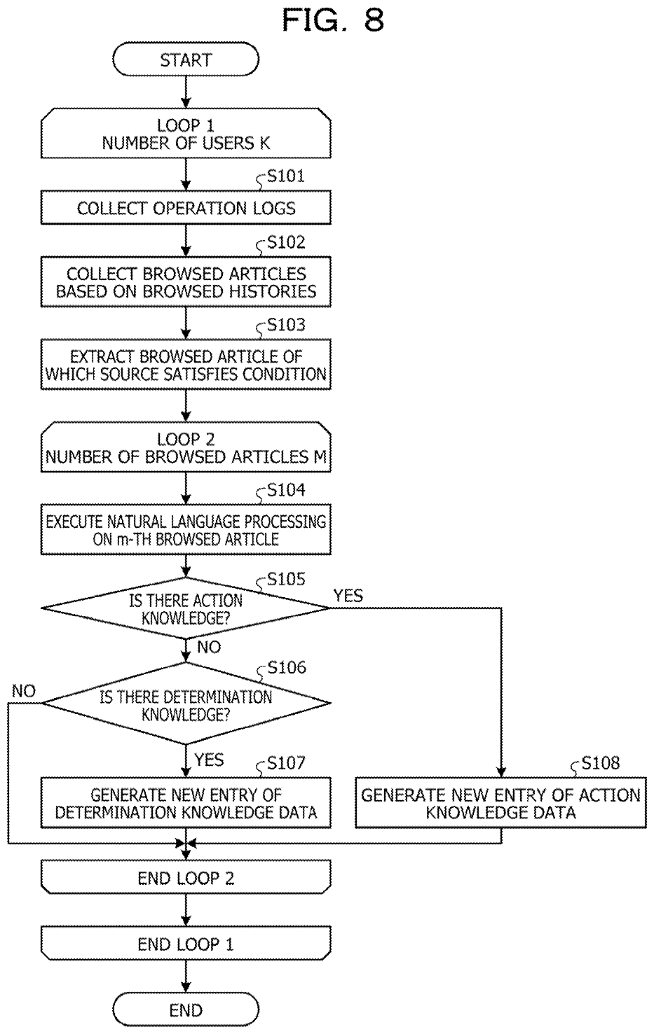

FIG. 8 is a flowchart illustrating a procedure of knowledge data collection processing. As an example only, this processing may be started at an arbitrary timing such as a periodic time, a certain cycle, or a command from a system administrator or the like.

As illustrated in FIG. 8 (with reference to FIG. 3), the collection unit 15A executes loop processing 1 in which processing from step S101 to step S108 is repeated the number of times corresponding to the number of users K who receive provision of the above-described measurement function. Although an example in which the processing from step S101 to step S108 is repeatedly executed is exemplified, the processing from step S101 to step S108 does not have to be repeated and may be executed in parallel.

For example, the collection unit 15A collects operation logs of the user terminal 30 from the user terminal 30 (step S101). Subsequently, the collection unit 15A acquires browsed articles corresponding to the browsed histories of the browser or the like included in the operation logs acquired in step S101 (step S102). The collection unit 15A extracts browsed articles in which sources of the browsed articles satisfy a specific condition among the browsed articles acquired in step S102 (step S103).

After that, the collection unit 15A executes loop processing 2 in which the processing from step S104 to step S108 is repeated the number of times corresponding to the number of the browsed articles M extracted in step S103. Although an example in which the processing from step S104 to step S108 is repeatedly executed is exemplified, the processing from step S104 to step S108 does not have to be repeated and may be executed in parallel.

For example, the collection unit 15A executes natural language processing such as morphological analysis on the text of the browsed article with an index m (step S104). Subsequently, based on the word included in the text of the browsed article with the index m, the collection unit 15A determines whether the action knowledge is included in the browsed article with the index m (step S105).

In a case where the action knowledge is included in the browsed article with the index m (Yes in step S105), the collection unit 15A executes the following processing. For example, the collection unit 15A generates a data entry related to the action knowledge from the browsed article with the index m and additionally registers the data entry in the action knowledge data 13B of the storage unit 13 (step S108).

In a case where the action knowledge is not included in the browsed article with the index m (No in step S105), it is determined whether the determination knowledge is included in the browsed article with the index m based on the word included in the text of the browsed article with the index m (step S106).

At this time, in a case where the determination knowledge is included in the browsed article with the index m (Yes in step S106), the collection unit 15A executes the following processing. For example, the collection unit 15A generates a data entry related to the determination knowledge from the browsed article with the index m and additionally registers the data entry in the determination knowledge data 13C of the storage unit 13 (step S107).

In a case where the action knowledge is not included in the browsed article with the index m and the determination knowledge is not included in the browsed article with the index m (No in step S105 and No in step S106), the action knowledge data 13B and the determination knowledge data 13C are not updated.

By repeating such loop processing 2, the update of the action knowledge data 13B or the determination knowledge data 13C is implemented for each M browsed articles for one user k. By repeating the loop processing 1, the update of the action knowledge data 13B or determination knowledge data 13C is implemented M times for each of users K.

### (2) Information Literacy Degree Measurement Processing

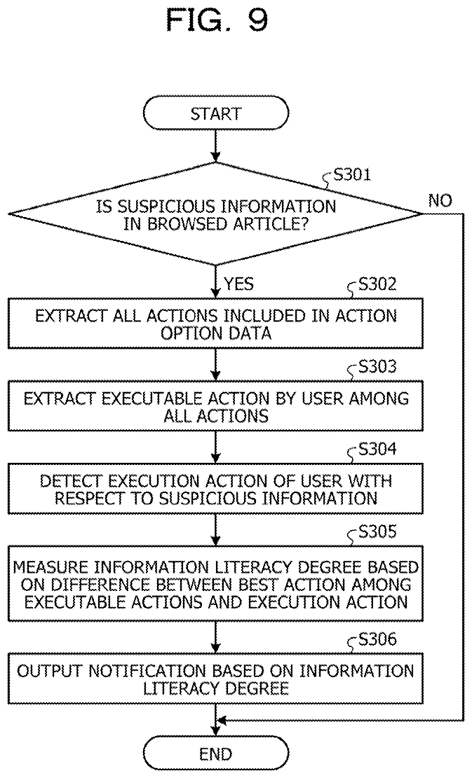

FIG. 9 is a flowchart illustrating a procedure of information literacy degree measurement processing. As an example only, this processing may be started in a case where a measurement request for the information literacy degree is received from the user terminal 30.

As illustrated in FIG. 9 (with reference to FIG. 3), when suspicious information is not included in the browsed article included in the browsed history (No in step S301), the processing ends. When suspicious information is included in the browsed article included in the browsed history (Yes in step S301), the prediction unit 15C extracts all the actions registered in the action option data 13D stored in the storage unit 13 (step S302).

Subsequently, the prediction unit 15C extracts an executable action of the user as an issue source of the measurement request among all the actions extracted in step S302 (step S303). The detection unit 15D detects the execution action executed by the user when browsing the suspicious information from the operation log of the user terminal 30 (step S304).

Based on a difference between the action with the best evaluation among the executable actions extracted in step S303 and the execution action detected in step S304, the measurement unit 15E measures an information literacy degree of the user (step S305).

After that, the output unit 15F outputs a notification including the information literacy degree measured in step S305 to the user terminal 30 (step S306), and the processing ends.

### One Aspect of Effects

As described above, the server apparatus 10 according to the present embodiment measures the information literacy degree based on a gap between the best action executable by the user specified from a browsed history of the user terminal and an execution action detected from an operation log of the user terminal when browsing the suspicious information. Accordingly, since it is possible to suppress underestimation of the user who does his/her best and overestimation of user who does not do his/her best, it is possible to improve the evaluation of the information literacy of the user who executes a better action among the actions executable with the knowledge amount of the user. Accordingly, with the server apparatus 10 according to the present embodiment, it is possible to implement a notification for prompting the suppression of the spread of the suspicious information in accordance with the information literacy of each person.

### Embodiment 2

Although the embodiment related to the apparatus of the disclosure has been described hitherto, the present disclosure may be carried out in various different forms other than the above-described embodiment. Another embodiment of the present disclosure will be described below.

### Distribution and Integration

The individual components of each illustrated apparatus are not necessarily physically configured as illustrated. For example, the specific form of the distribution and integration of each apparatus is not limited to the illustrated form, and all or a part of the apparatus may be configured in arbitrary units in a functionally or physically distributed or integrated manner depending on various kinds of loads, usage statuses, and the like. For example, the collection unit 15A, the specification unit 15B, the prediction unit 15C, the detection unit 15D, the measurement unit 15E, or the output unit 15F may be coupled via a network as an external apparatus of the server apparatus 10. The functions of the server apparatus 10 may be implemented by having separate apparatuses each having the collection unit 15A, the specification unit 15B, the prediction unit 15C, the detection unit 15D, the measurement unit 15E, or the output unit 15F, and being coupled to a network and cooperating. The functions of the server apparatus 10 may be implemented by having separate apparatuses each having all or a part of the operation log data 13A, the action knowledge data 13B, the determination knowledge data 13C, or the action option data 13D stored in the storage unit 13, and being coupled to a network and cooperating.

### Hardware Configuration

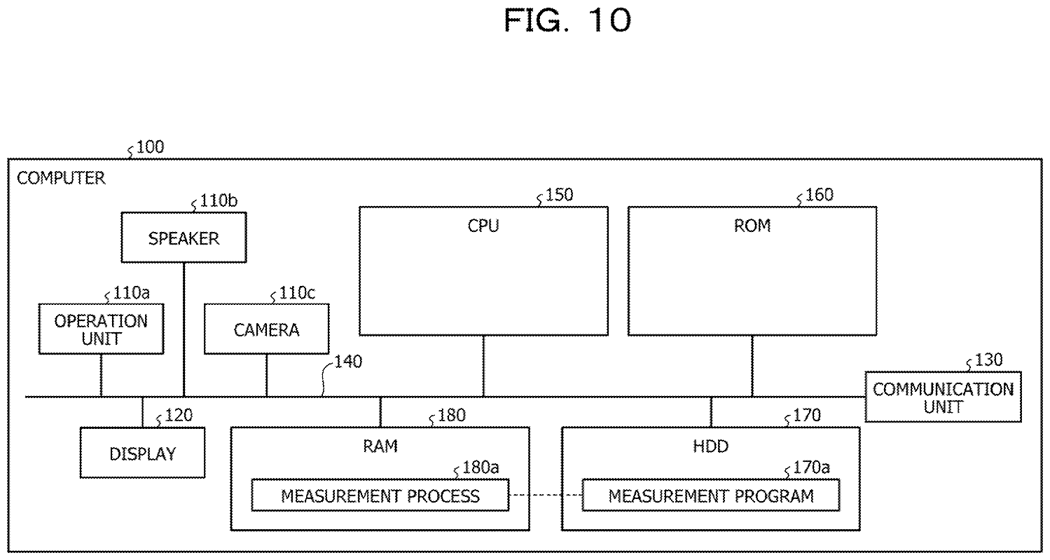

The various kinds of processing described in the above embodiments may be implemented when a program prepared in advance is executed by a computer such as a personal computer or a workstation. An example of the computer that executes a measurement program having similar functions to those of the Embodiments 1 and 2 will be described below with reference to FIG. 10.

FIG. 10 is a diagram illustrating a hardware configuration example. As illustrated in FIG. 10, a computer 100 includes an operation unit 110a, a speaker 110b, a camera 110c, a display 120, and a communication unit 130. The computer 100 also includes a central processing unit (CPU) 150, a read-only memory (ROM) 160, a hard disk drive (HDD) 170, and a random-access memory (RAM) 180. These components 110 to 180 are coupled to each other via a bus 140.

As illustrated in FIG. 10, the HDD 170 stores a measurement program 170a that exhibits the same functions as those of the collection unit 15A, the specification unit 15B, the prediction unit 15C, the detection unit 15D, the measurement unit 15E, and the output unit 15F described in Embodiment 1 above. This measurement program 170a may be integrated or separated as with each of the components of the collection unit 15A, the specification unit 15B, the prediction unit 15C, the detection unit 15D, the measurement unit 15E, and the output unit 15F illustrated in FIG. 3. For example, not all of the pieces of data described in the Embodiment 1 above is necessarily stored in the HDD 170. It is sufficient that data used for the processing be stored in the HDD 170.

Under such an environment, the CPU 150 reads the measurement program 170a from the HDD 170 and loads the measurement program 170a onto the RAM 180. As a result, the measurement program 170a functions as a measurement process 180a, as illustrated in FIG. 10. The measurement process 180a loads various kinds of data read from the HDD 170 in an area allocated to the measurement process 180a in a storage area included in the RAM 180 and executes various kinds of processing by using the loaded various kinds of data. For example, processing executed by the measurement process 180a may include the processing and the like illustrated in FIG. 8 or 9 as an example. Not all the processing units described in Embodiment 1 above necessarily operate on the CPU 150. It is sufficient that processing units corresponding to the processing to be executed be virtually implemented.

The above-described measurement program 170a is not necessarily initially stored in the HDD 170 or the ROM 160. For example, the measurement program 170a is stored in a “portable physical medium” such as a flexible disk called an FD, a compact disc (CD)-ROM, a Digital Versatile Disc (DVD) disk, a magneto-optical disk, or an integrated circuit (IC) card to be inserted into the computer 100. The computer 100 may acquire the measurement program 170a from the portable physical medium and execute the acquired measurement program 170a. The measurement program 170a is stored in another computer, a server apparatus, or the like coupled to the computer 100 via a public network, the Internet, a LAN, a wide area network (WAN), or the like. The measurement program 170a stored in this manner may be downloaded to the computer 100 and then executed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a measurement program for causing a computer to execute a process comprising:
measuring a knowledge amount of a user related to an action when responding to suspicious information from a browsed history of a user terminal;
specifying the suspicious information among browsed articles included in the browsed history;
predicting executable actions by the user from the knowledge amount;
detecting, from an operation log of the user terminal, an execution action executed by the user when browsing the suspicious information; and
measuring an information literacy degree of the user based on a difference between an action with a best evaluation among the executable actions and the execution action.

2. The non-transitory computer-readable recording medium according to claim 1,
wherein the measuring includes measuring a lower information literacy degree as the difference increases.

3. The non-transitory computer-readable recording medium according to claim 1, further causing the computer to execute:
outputting a notification based on the information literacy degree measured in the measuring.

4. The non-transitory computer-readable recording medium according to claim 3,
wherein the outputting includes outputting a notification based on the information literacy degree when the information literacy degree is equal to or lower than a threshold.

5. The non-transitory computer-readable recording medium according to claim 3,
wherein the outputting includes outputting a recommendation notification that prompts an action that is able to be measured with a higher information literacy degree than the information literacy degree measured based on the execution action detected in the detecting.

6. A measurement method performed by a computer, the method comprising:
measuring a knowledge amount of a user related to an action when responding to suspicious information from a browsed history of a user terminal;
specifying the suspicious information among browsed articles included in the browsed history;
predicting executable actions by the user from the knowledge amount;
detecting, from an operation log of the user terminal, an execution action executed by the user when browsing the suspicious information; and
measuring an information literacy degree of the user based on a difference between an action with a best evaluation among the executable actions and the execution action.

7. The measurement method according to claim 6,
wherein the measuring includes measuring a lower information literacy degree as the difference increases.

8. The measurement method according to claim 6, further causing the computer to execute:
outputting a notification based on the information literacy degree measured in the measuring.

9. The measurement method according to claim 8,
wherein the outputting includes outputting a notification based on the information literacy degree when the information literacy degree is equal to or lower than a threshold.

10. The measurement method according to claim 8,
wherein the outputting includes outputting a recommendation notification that prompts an action that is able to be measured with a higher information literacy degree than the information literacy degree measured based on the execution action detected in the detecting.

11. A measurement apparatus comprising:
a memory, and
a processor coupled to the memory and configured to:
measure a knowledge amount of a user related to an action when responding to suspicious information from a browsed history of a user terminal;
specify the suspicious information among browsed articles included in the browsed history;
predict executable actions by the user from the knowledge amount;
detect, from an operation log of the user terminal, an execution action executed by the user when browsing the suspicious information; and
measure an information literacy degree of the user based on a difference between an action with a best evaluation among the executable actions and the execution action.

12. The measurement apparatus according to claim 11,
wherein the measure includes measuring a lower information literacy degree as the difference increases.

13. The measurement apparatus according to claim 11, the processor is further configured to:
output a notification based on the information literacy degree measured in the measuring.

14. The measurement apparatus according to claim 13,
wherein the output includes outputting a notification based on the information literacy degree when the information literacy degree is equal to or lower than a threshold.

15. The measurement apparatus according to claim 13,
wherein the output includes outputting a recommendation notification that prompts an action that is able to be measured with a higher information literacy degree than the information literacy degree measured based on the execution action detected in the detecting.
